(19) United States
(12) Patent Application Publication
(10) Pub. No.: US 2013/0153305 A1
(43) Pub. Date: Jun. 20, 2013

(54) Drag Drill Bit With Hybrid Cutter Layout Having Enhanced Stability

(71) Applicant: Benjamin CHREST, Black River Falls, WI (US)

(72) Inventor: Benjamin CHREST, Black River Falls, WI (US)

(73) Assignee: ULTERRA DRILLING TECHNOLOGIES, L.P.

(21) Appl. No.: 13/327,577

(22) Filed: Dec. 15, 2011

(51) Int. Cl. E21B 10/00; B23P 15/28

(52) U.S. Cl. 175/336; 76/108.4

(57) ABSTRACT

A drill bit that provides enhanced stability and a method for manufacturing such bit. In a preferred embodiment, the hybrid drill bit includes a single short driven blade in the shoulder region of the bit having each of its primary cutters plural set, sharing a common radial/elevational position with a primary cutter in an adjacent blade. All other primary cutters of the drill bit are single set at unique radial/elevational positions. The trailing plural-set cutters do less work than the other cutters and disrupt resonance and the feedback mechanism that leads to vibration, instability and whirling. In alternate embodiments, multiple blade pairs or groups may have primary cutters in the shoulder region that are plural set, sharing common radial/elevational positions with other primary cutters.

### BACKGROUND OF THE INVENTION

1. Field of the Invention

This invention relates generally to earth-boring drill bits used to drill wells, for example, in the oil and gas industry, and more particularly, to fixed cutter or rotary drag drill bits.

2. Background Art

Fixed cutter bit designs, such as that embodied in the drill bit (199) illustrated in FIGS. 1 and 2, typically include a bit body (198) formed of steel or matrix material and a number of blades (110, 120, 130, 140, 150). The blades radially extend across the bit face and define grooves or junk slots (119, 129, 139, 149, 159). Nozzles (191) supply drilling fluid for cooling the blades and flushing formation cuttings away from the bit through the junk slots.

Most fixed cutter bits have a predominant blade (110) that spans the entire distance from the bit axis in the cone region to the outer gauge region, while the other blades are typically shorter. The predominant blade (110) may be referred to as the “driving” blade, while the remaining blades (120, 130, 140, 150) may be referred to as “driven” blades.

Each blade carries a number of hardened cutters that scrape and remove earthen formation material as the bit is rotated in the bore hole. Cutters are often arranged in one or more rows on each blade. A cutter that lies along the leading edge of a blade is known as a primary cutter. The cutters typically include tungsten carbide, polycrystalline diamond compact (“PDC”), or thermally stabilized polycrystalline diamond (“TSP”) material. Cutters are often mounted on a cylindrical support member, which is in turn inserted into a pocket formed in the surface of the bit.

The configuration or layout of the cutters on the blades varies widely, depending on the formation environment in which the bit is to be used. Regardless of the specific configuration, cutters are arranged so that, in the aggregate, substantially full bottom hole coverage is obtained. That is, the cutters are arranged so that when the bit is rotated, substantially the entire distance from the rotation axis to the gauge of the bit is engaged by at least one cutter.

Bits may be classified based on primary cutter redundancy. For instance, each primary cutter may be located at a unique radial/elevational position with respect to the rotational axis of the bit. Such bits are known in the art as “single set” bits. Single set bits are efficient in formation cutting. The unique radial/elevational position of each cutter is more clearly visible in the revolved profile view of FIG. 2, in which the radial component of the cutter position is measured horizontally and the elevational component of the cutter position is measured vertically.

FIG. 2 is a revolved profile (197) of the single set drill bit (199) of FIG. 1. A revolved profile view depicts the cutting path of cutters on multiple the blades together on a common radial plane as the cutters would pass through that radial plane if the bit was revolved about its rotational axis. Such profile views are commonly used by routineers in the art. Bit (99) includes a cone region, an nose and shoulder region, and a gauge region. Such regions are more readily identified on revolved profile (197). Starting from the bit centerline (193) and extending radially outward, profile (197) consists of a linear cone region (194), and arcuate nose and shoulder region (195), and a linear gauge region (196).

For simplicity, FIG. 2 shows cutting paths for just a portion of the shoulder region of the bit. A pair of shoulder region circles (112′, 113′) represent the cutting path of adjacent cutters (112, 113) on the driving blade (110) of drill bit (199). Four interstitial shoulder region circles (123′, 133′, 143′, 153′) are illustrated between the driving blade circle pair (112′, 113′). These four interstitial circles represent the cutting paths of the shoulder region cutters (123, 133, 143, 153) on the driven blades (120, 130, 140, 150).

Another type of drill bit is a “plural set” bit. A plural set bit includes two or more primary cutters at essentially the same radial/elevational position with respect to the bit rotational axis. In other words, at least one primary cutter is paired with a redundant primary cutter disposed on a different blade at about the same radial/elevational position with respect to the bit axis. Typically, in a plural-set bit, a large percentage of the primary cutters are redundant.

Bit stability, the tendency to resist vibration, is an important characteristic of a drill bit. A severe mode of instability, referred to as “whirl,” is the phenomenon in which a drill bit rotates about an axis that is offset from the geometric center of the bit. Whirling subjects the cutting elements on the bit to increased loading, which results in rapid wearing of the cutting elements and may cause destruction of the bit.

Several prior art patents are concerned with improving bit stability. For example, U.S. Pat. No's. 5,109,935 and 5,010,789 disclose techniques for reducing whirl by compensating for imbalance in a controlled manner. Similarly, U.S. Pat. No. 7,621,348 discloses an asymmetric bit with both active and passive cutting regions that reduces the tendency of the bit to whirl. However, the industry always desires improved bits that will yield greater rates of penetration with greater stability and longer life.

3. Identification of Objects of the Invention

A primary object of the invention is to provide an efficient drill bit having greater stability and a method for producing such a drill bit.

Another object of the invention is to provide a drill bit capable of high rates of penetration without propensity to whirl.

### SUMMARY OF THE INVENTION

The objects described above and other advantages and features of the invention are incorporated in a method for producing a hybrid drill bit that provides enhanced stability and a drill bit manufactured according to this method. In a preferred embodiment, the hybrid drill bit includes a short driven blade in which its primary cutters in the shoulder region are plural set, sharing common radial/elevational positions with primary cutters in an adjacent blade. All other primary cutters of the drill bit are single set at unique radial/elevational positions.

According to a first embodiment, only a single pair of adjacent blades includes plural set primary cutters. The trailing plural-set cutters do less work than all of the other cutters, which is believed to disrupt resonance and the feedback mechanism that leads to vibration, instability and whirling. It is also preferred that only cutters in the shoulder and/or gauge region are plural set. Finally, it is preferred that at least one of the driven blades cover only the outer shoulder and/or gauge regions, and not the inner cone region, and that all of the shoulder region cutters on such short driven blade are plural set.

According to another embodiment, there may be greater than two plural-set blades. For instance, up to one-half of the total blade count of the bit may include shoulder-region primary cutters that are plural set with other primary cutters.

### BRIEF DESCRIPTION OF THE DRAWINGS

The invention is described in detail hereinafter on the basis of the embodiments represented in the accompanying figures, in which:

FIG. 1 is an end view of a conventional rotary drag drill bit as known in the prior art, showing five blades populated with single-set primary cutters each located at a unique radial/elevational position on the bit;

FIG. 2 is a revolved profile view of the cutter arrangement of the single-set prior art bit of FIG. 1, showing the unique radial/elevational cutter positions for a portion of the cutters in the shoulder region of the bit;

FIG. 3 is an end view of a six-bladed hybrid rotary drag drill bit according to a first embodiment of the invention that is characterized by substantially the same revolved profile as the conventional five-bladed single-set bit of FIG. 1, showing a single secondary blade in the shoulder region that is populated with primary cutters that are plural set with primary cutters of an adjacent blade;

FIG. 4 is a revolved profile view of the cutter arrangement of the hybrid bit of FIG. 3, showing the cutter positions that cover the same radial distance as the profile view of FIG. 2; and

FIG. 5 is an end view of a seven-bladed hybrid rotary drag bit according to a second embodiment of the invention that is characterized by multiple plural-set blade pairs or groups having primary and redundant primary cutters in the shoulder region of the bit.

### DESCRIPTION OF THE PREFERRED EMBODIMENT OF THE INVENTION

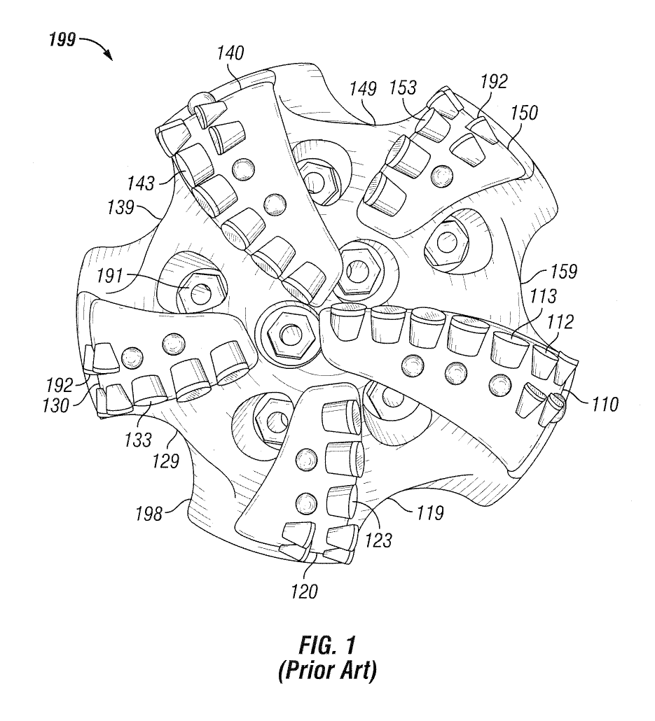

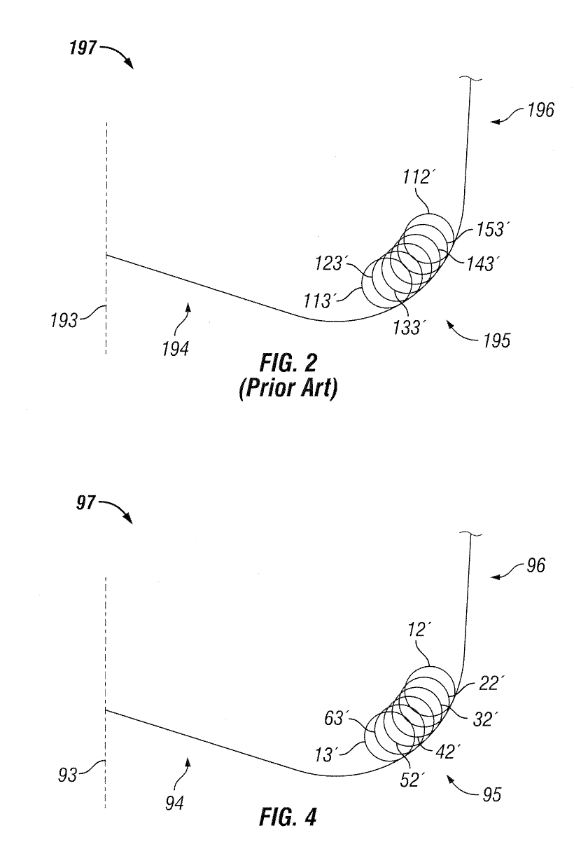

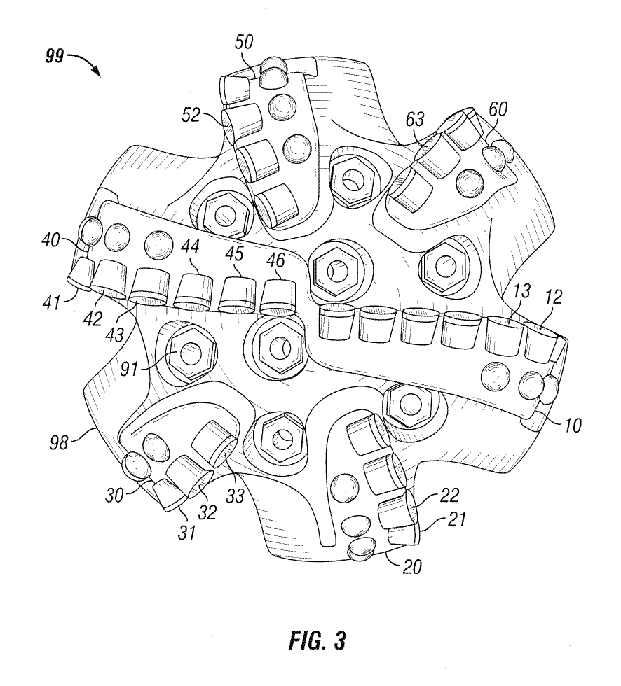

FIG. 3 illustrates a hybrid drag bit 99 according to a preferred embodiment of the invention. Bit 99 is characterized by a revolved profile (FIG. 4) that is essentially the same as the revolved profile (FIG. 2) of prior art bit 199 (FIG. 1), even though hybrid bit 99 includes one blade more than prior art bit 199.

Bit 99 includes a body 98 and six blades 10, 20, 30, 40, 50, 60, although other numbers of blades may be used within the scope of this invention. Blade 10 is a driving blade that covers the rotational axis in the cone region of bit 99 and extends through the shoulder region of the bit. Blades 20, 30,40, 50 and 60 are driven blades, which are shorter than driving blade 10 and do not extend fully to the bit rotational axis. Nozzles 91 are provided in the junk slots between the blades.

Each of the primary cutters on blades 10, 20, 50 and 60 are single set, having a unique radial/elevational position on bit 99. Cone region cutters 44, 45 and 46 on blade 4 are also single set. However, according to a preferred embodiment of the invention, primary cutters 31, 32 and 33 of blade 3 are plural set with primary cutters 41, 42 and 43 of adjacent blade 40. That is, cutters 31 and 41 form a pair, each having essentially the same radial/elevational position. The same is true of cutters 32 and 42 and of cutters 33 and 43.

FIG. 4 is a revolved profile view showing a revolved profile 97 of a portion of the cutter arrangement of FIG. 3. The circles 13′, 63′, 52′, 22′ and 12′ indicate the unique radial/elevational positions of cutters 13, 63, 52, 22 and 12 of bit 99 of FIG. 3, respectively. Note that a single circle 42′/32′ indicates the common radial/elevational position shared by both cutters 42 and 32.

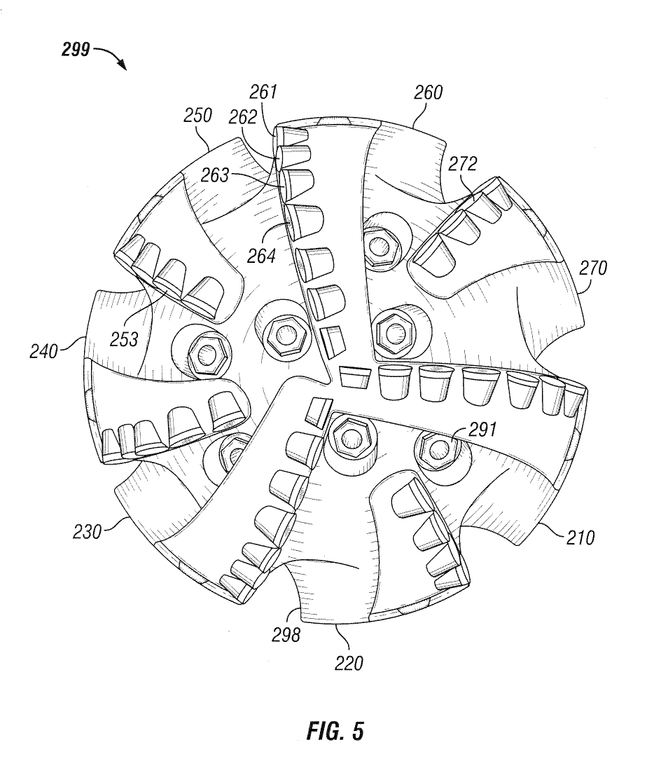

According to the embodiment of FIG. 3, only a single pair of adjacent blades 30, 40 includes plural set primary cutters. However, in alternate embodiments, there may be more than two plural-set blades. For instance, an embodiment having more than two plural-set blades is shown in FIG. 5. Drill bit 299 includes a bit body 298 and seven blades 210, 220, 230, 240, 250, 260, 270 formed thereon. Nozzles 294 are provided in the junk slots between the blades. Blade 260 includes a first shoulder-region primary cutter 262 that is plural set with shoulder-region primary cutter 272 on blade 270. Likewise, shoulder-region primary cutter 263 on blade 260 is plural set with shoulder-region primary cutter 253 on blade 250. Indeed, it is possible for up to half of the total blade count of the bit to have primary cutters in the shoulder region of the bit 299 that are plural set at common radial/elevational positions with primary cutters on one or more other blades.

The trailing plural-set cutters do less work than all of the other cutters, which is believed to disrupt resonance and the feedback mechanism that leads to vibration, instability and whirling. Because cutters at greater radii from the axis travel faster as the bit rotates, outer shoulder and gauge region cutters have the most effect on stability. Accordingly, is also preferred that only cutters in the shoulder and/or gauge region are plural set. Finally, it is preferred that at least one of the driven blades covers only the outer shoulder and/or gauge regions, and not the inner cone region, and that all of the shoulder region cutters on such short driven blade are plural set.

The Abstract of the disclosure is written solely for providing the United States Patent and Trademark Office and the public at large with a way by which to determine quickly from a cursory reading the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations of the above embodiment may occur to those skilled in the art. Such modifications and adaptations are in the spirit and scope of the invention as set forth herein:

What is claimed is:

1. A drill bit (99) comprising:
a bit body (98) defining a rotational axis (93) and a bit face with a cone region (94), a shoulder region (95), and a gauge region (96);
a driving blade (10) formed on said bit body (98), said driving blade (10) extending from near said rotational axis across said bit face to at least said shoulder region;
first and second driven blades (30, 40) formed on said bit body (98); and
a plurality of primary cutters disposed along leading edges of said driving blade (10) and said first and second driven blades (30, 40); wherein
said primary cutters (12, 13) on said driving blade are characterized by having a unique radial/elevational position with respect to all other primary cutters on said bit (99),
each of said primary cutters (31, 32, 33) on said first driven blade (30) are characterized by having a substantially redundant radial/elevational position with one of said primary cutters (41, 42, 43) on said second driven blade (40), and
the remaining of said plurality of primary cutters (44, 45, 46) on said second driven blade (40) that do not have said redundant radial/elevational position with one of said primary cutters (31, 32, 33) on said first driven blade (30) are characterized by having a unique radial/elevational position with respect to all other primary cutters on said bit (99).

2. The drill bit (99) of claim 1 further comprising:
a third driven blade (20) formed on said bit body (98);
a plurality of primary cutters (21, 22) disposed along a leading edge of said third driven blade (20), each of said plurality of primary cutters (21, 22) on said third driven blade (20) characterized by having a unique radial/elevational position with respect to all other primary cutters on said bit (99).

3. The drill bit (99) of claim 1 further comprising:
a plurality of driven blades (20, 50, 60) formed on said bit body in addition to said first and second driven blades (30, 40);
a plurality of primary cutters (21, 22, 52, 63) disposed along leading edges of said plurality of driven blades (20, 50, 60), each of said plurality of primary cutters on said plurality of driven blades characterized by having a unique radial/elevational position with respect to all other primary cutters on said bit (99).

4. The drill bit (99) of claim 1 wherein:
said first driven blade (30) is disposed predominantly in said shoulder region of said bit face.

5. A drill bit (99) comprising:
a bit body (98);
a plurality of blades formed on said bit body (10, 20, 30, 40, 50, 60), each of said plurality of blades defining a leading edge;
a plurality of shoulder-region primary cutters distributed on said leading edges of said plurality of blades in a shoulder region (95) of said bit (99);
a first blade (30) of said plurality of blades including a first (31) of said plurality of shoulder-region primary cutters that is characterized by a substantially redundant radial/elevational position with a second (41) of said plurality of shoulder-region primary cutters disposed on a second blade (40) of said plurality of blades.

6. The drill bit (99) of claim 5 further comprising:
a first group (31, 32, 33) of said plurality of shoulder-region primary cutters disposed on said first blade that are characterized by substantially redundant radial/elevational positions with a second group (41, 42, 43) of said plurality of shoulder-region primary cutters that are disposed on said second blade (40).

7. The drill bit (99) of claim 6 wherein:
all of said plurality of shoulder-region primary cutters that are not in said first group (31, 32, 33) or said second group (41, 42, 43) are characterized by unique radial/elevational positions.

8. The drill bit (99) of claim 6 wherein:
all of said plurality of shoulder-region primary cutters that are disposed on said first blade (30) are members of said first group (31, 32, 33) having redundant radial/elevational positions with said second group (41, 42, 43) on said second blade (40).

9. The drill bit (99) of claim 5 wherein:
said first blade (30) is adjacent to said second blade (40).

10. The drill bit of claim 5 further comprising:
a third blade of said plurality of blades including a third of said plurality of shoulder-region primary cutters that is characterized by substantially redundant radial/elevational positions with a fourth of said plurality of shoulder-region primary cutters disposed on a fourth blade of said plurality of blades.

11. A method for manufacturing a drill bit (99) having improved stability comprising the steps of:
forming a bit body (98) having at least first, second, and third blades (10, 30, 40) and a plurality of shoulder-region primary cutters disposed on said first, second, and third blades (10, 30, 40) in a shoulder region (95) of said bit (99); and
disposing a first one (31) of said plurality of primary cutters on said second blade (30) at the same radial/elevational positions as a second one (41) of said plurality of primary cutters in a shoulder region of said third blade (40).

12. The method of claim 11 further comprising the step of:
disposing a first group (31, 32, 33) of said plurality of shoulder-region primary cutters on said first blade at substantially redundant radial/elevational positions with a second group (41, 42, 43) of said plurality of shoulder-region primary cutters that are disposed on said second blade (40).

13. The method of claim 12 further comprising the step of:
disposing all other of said plurality of shoulder-region primary cutters that are not in said first or second groups at unique radial/elevational positions on said drill bit (99).

14. The method of claim 11 wherein:
all of the primary cutters on said second blade (30) are in said first group and are plural set at redundant radial/elevational positions.

15. The method of claim 11 further comprising the step of:
forming said second blade (30) so that it substantially does not lie within a cone region of said bit (99).

16. The method of claim 11 wherein:
said second blade (30) is disposed adjacent to said third blade (40).

17. The method of claim 11 further comprising the steps of:
disposing a third of said plurality of shoulder-region primary cutters on said first blade so that is characterized by substantially redundant radial/elevational positions with a fourth of said plurality of shoulder-region primary cutters disposed on said second blade of said plurality of blades.

18. In a method for manufacturing an improved drill bit having substantially the characteristics of single-set drill bit (199) of a number n blades (110, 120, 130, 140, 150) formed on a bit body (198) with a plurality of primary cutters disposed on each of said n blades, wherein each of said plurality of primary cutters is located at a unique radial/elevational position on said bit (199), said single-set drill bit (198) defining a particular single-set revolved profile (197), the improvement providing enhanced stability and comprising the steps of:
forming a drill bit (99) of n+1 blades (10, 20, 30, 40, 50, 60) on a bit body (98), wherein n of said n+1 blades (10, 20, 40, 50, 60) define a hybrid revolved profile (97) substantially identical to said particular single-set revolved profile (197); and
disposing a plural-set primary cutter (31) on said (n+1)^{th} blade (30) so as to have a redundant radial/elevational position with one (41) of said plurality of primary cutters.

19. The method of claim 18 further comprising the steps of:
disposing a plurality of plural-set primary cutters (31, 32, 33) on said n+1^{th} blade (40) so that at least one of said plurality of plural-set primary cutters within a shoulder region (95) of the bit (99) has a redundant radial/elevational position with another of said plurality of primary cutters.

20. The method of claim 18 further comprising the steps of:
disposing a plurality of plural-set primary cutters (31, 32, 33) on said n+1^{th} blade (40) so that each of said plurality of plural-set primary cutters has a redundant radial/elevational position with one of said plurality of primary cutters (41, 42, 43).

21. The method of claim 18 further comprising the steps of:
forming said n+1^{th} blade (30) so that it substantially does not lie within a cone region of said bit (99).
